(19) United States
(12) Patent Application Publication
(10) Pub. No.: US 2016/0346792 A1
(43) Pub. Date: Dec. 1, 2016

(54) DEVICE FOR FILTERING A LIQUID BY CYCLONIC EFFECT

(71) Applicant: PISCINES DESJOYAUX SA, La Fouillouse (FR)

(72) Inventors: Marc Dejey, Aix les Bains (FR); Florian Arot, Montagnieu (FR); Jean-Louis Desjoyaux, Chalain le Comtal (FR); Céline Sage, Veauche (FR); Thibault Parin, Genilac (FR)

(21) Appl. No.: 15/115,195

(22) PCT Filed: Jan. 29, 2015
(86) PCT No.: PCT/FR2015/050206

§ 371 Date: Jul. 28, 2016

(30) Foreign Application Priority Data
Jan. 29, 2014 (FR) 1450701

(51) Int. Cl. B04C 5/181; E04H 4/12; B04C 9/00

(52) U.S. Cl. CPC B04C 5/181; B04C 9/00; E04H 4/1209; B04C 2009/007

(57) ABSTRACT

The disclosure relates to a filtering device that comprises a tubular body with a cylindrical segment extended at one of the ends thereof by a conical segment with a tapering section, the other end of the cylindrical segment being in lateral communication with a fitting for the entry of the liquid to be filtered tangentially to the circumference of the body next to the wall such that solid particles of the liquid, under the effect of the centrifugal force, tend to be pushed against the wall, the fluid following the wall until the apex and rising back up free of at least some of the particles via the center of the body so as to be discharged via a coaxial fitting of the cylindrical segment. The end of the conical segment considered at the apex thereof, has means capable of allowing the extraction and discharge of solid particles captured at the wall of the body in order to guide the same into a tank in communication with the coaxial fitting.

### CROSS-REFERENCE TO RELATED APPLICATIONS

This application is a national phase entry under 35 U.S.C. §371 of International Patent Application PCT/FR2015/050206, filed Jan. 29, 2015, designating the United States of America and published as International Patent Publication WO 2015/114260 A1 on Aug. 6, 2015, which claims the benefit under Article 8 of the Patent Cooperation Treaty to French Patent Application Serial No. 1450701, filed Jan. 29, 2014.

### TECHNICAL FIELD

The application relates to a device for filtering a liquid by cyclonic effect. More particularly, the disclosure finds an advantageous application for the filtration of water, specifically in a swimming pool. More generally, the disclosure relates to the filtration of all fluids that may contain particles, including fine particles.

### BACKGROUND

In the field of the filtration of water in a swimming pool, many technical solutions have been proposed. For example, filter cartridges made from a preformed accordion-folded polyester weft and positioned radially along the generatrix lines of a cylinder can be cited. The base of the cartridge may be in communication with a suction system for providing the filtration of the water, which is typically supplied from the outside of the cartridge so as to pass through the walls thereof. Embedding and cleaning problems may arise.

Another solution for filtering water consists of using a sleeve, one of the ends of which is open and the opposite end of which is closed, thereby forming a sock. The sleeve is made of a non-woven material with filtering capability. For example, according to the teachings of patent EP 0423043, the sleeve, generally frusto-conical in shape, is mounted in a cylindrical holder, the bottom of which is in relation with a water suction and discharge system. Thanks to the low pressure, water is directly supplied through the open end of the sleeve to be discharged by the suction and discharge system into the basin, after being subjected to the filtering power of the sleeve.

The sleeve is removably mounted in the cylindrical holder to be easily washable.

Whatever type of filtration, using a cartridge or a sock, the filter element must be frequently cleaned, which can, in the long run, be a constraint.

Using the devices known as hydrocyclones and implementing a centrifugal force for mechanically separating the particles, has also been proposed to ensure the separation of solid particles contained in a liquid. Such devices comprise a body consisting of a cylindrical part and a frusto-conical part into which the fluid is tangentially introduced at the circumference of the body, in the vicinity of its wall, in a turning movement. Under the effect of the centrifugal force, the solid particles captured by the centrifugal force are projected toward the wall. The fluid follows the wall of the body to the vicinity of the apex and rises back up by a vortex effect at its center to be discharged through an opening formed coaxially with the upper part of the body. For the particle separation to be effective, it proved necessary that the time taken for a particle to reach the wall, should be less than the average residence time of a fluid element in the cyclone. Such provisions make it possible to properly size the device, according to the desired results.

The cyclonic effect to ensure the filtration of a fluid in the case of a pool, has been taught, for example, by the document FR 2,967,922 which relates to a device for filtering the debris of a fluid, by creating a whirlwind of that fluid within a filter in the form of a hydrocyclone so as to obtain the deposition of some of the debris.

Such systems for filtering a liquid by cyclonic effect do not use filtering means in the form of a cartridge or a sock as indicated with the disadvantages thereof. However, the results obtained are not completely satisfactory for filtering fine particles which may sometimes be difficult to separate from the liquid and some of which may be carried away upon the rising back up of the liquid and the discharge thereof through the upper part of the body of the hydrocyclone as mentioned.

### BRIEF SUMMARY

The aim of the disclosure is to remedy these drawbacks in a simple, safe, effective and efficient way.

The problem to be solved by the disclosure consists of ensuring the filtration of all types of liquid that may contain particles of different sizes, including micro-particles, with the aim of capturing all or almost all of these particles while avoiding any re-injection phenomenon, for example, into an enclosure containing the liquid to be filtered.

To solve this problem, a device has been provided for filtering a liquid by cyclonic effect comprising a tubular body with a cylindrical segment extended at one of the ends thereof by a conical segment with a tapering section, with the other end of the cylindrical segment being in lateral communication with a fitting for the entry of the liquid to be filtered tangentially to the circumference of the body next to the wall, such that solid particles of the liquid under the effect of the centrifugal force tend to be pushed against the wall, the fluid following the wall until the apex and rising back up free of at least some of the particles via the center of the body so as to be discharged via a coaxial fitting of the cylindrical segment.

According to the disclosure and considering the problem to be solved, the end of the conical segment considered at the apex thereof has means capable of allowing the extraction and discharge of solid particles captured at the wall of the body in order to guide the same into a tank in communication with the coaxial fitting.

The result of such characteristics is that all of the captured particles are discharged into a settling tank.

Another problem to be solved by the disclosure consists of improving the capture of the particles at the inlet of the hydrocyclone by guiding the same against the wall of the body, while preventing the re-injection of some particles upon the rising back up of the liquid.

To solve this problem, the body has, coaxially with the cylindrical surface thereof, means capable of pushing back the particles onto the wall of the body upon the entry of the liquid and of pushing back the particles, if any, that the liquid might still contain, during the rising back up of the liquid. It consists of a turbine in the center, which is free to rotate.

To solve the problem of creating a closed circuit in order to improve the processing of fine particles, the tank in communication with the fitting for the outgoing water is associated with a suction circuit in order to create a continuous stream, with a filter being positioned between the tank and the fitting for the outgoing water with the aim to continuously improve the quality of the filtering by cyclonic effect.

In one embodiment, the fittings at the end of the conical segment at the apex thereof consist of a turbine positioned in coaxial alignment with an endless screw, with the turbine and the screw being so mounted as to be free to rotate in a sleeve providing the connection and the communication between the end and the tank.

In one embodiment, the fittings of the body at the cylindrical segment thereof consist of a dual turbine mounted so as to be free to rotate arranged coaxially to the cylindrical segment. The dual turbine consists of two internal and external concentric turbines, the internal turbine has blades oriented so as to deflect the flow of the incoming liquid against the wall of the body whereas the external turbine has blades oriented so as to deflect the particles outward, toward the wall during the rising back up of the liquid.

According to another characteristic and to solve the problem of cleaning the tank, the latter is equipped with means capable of enabling the simultaneous supply thereof with water from the network or the filtration unit and closing of the hydrocyclone for the emptying thereof in relation with an external pipe.

According to another characteristic, the internal wall of the conical segment of the body has fittings for facilitating the flow toward the apex of the captured particles. The fittings of the internal wall of the conical segment of the body consist of a rib forming a helicoid.

In an advantageous application of the device according to the disclosure, the device for filtering a liquid by cyclonic effect is mounted in combination with a suction and discharge circuit for the water of a swimming pool.

In this application, the fittings for the entry of the liquid consist of a pipe in communication with the water of a swimming pool via at least one skimmer. The fittings for the discharge of the filtered liquid consist of a pipe connected to the suction circuit of a pump for the discharge into a swimming pool 10.

### BRIEF DESCRIPTION OF THE DRAWINGS

The disclosure is described below in greater detail using the figures of the appended drawings wherein:

FIG. 1 is a perspective view showing the principle of operation of the device for filtering a liquid by cyclonic effect according to the embodiments of the disclosure;

FIG. 2 is a perspective view of an exemplary embodiment of the means capable of allowing the extraction and discharge of solid particles captured at the wall of the body and of the tank arranged for the supply thereof with network water and closing of the hydrocyclone;

FIG. 3 is a perspective view of an exemplary embodiment of the means mounted at the inlet of the hydrocyclone in order to push back the particles against the wall of the body; and

FIG. 4 is a perspective view of an exemplary embodiment of the means mounted at the inlet of the hydrocyclone in order to push back the particles against the wall of the body.

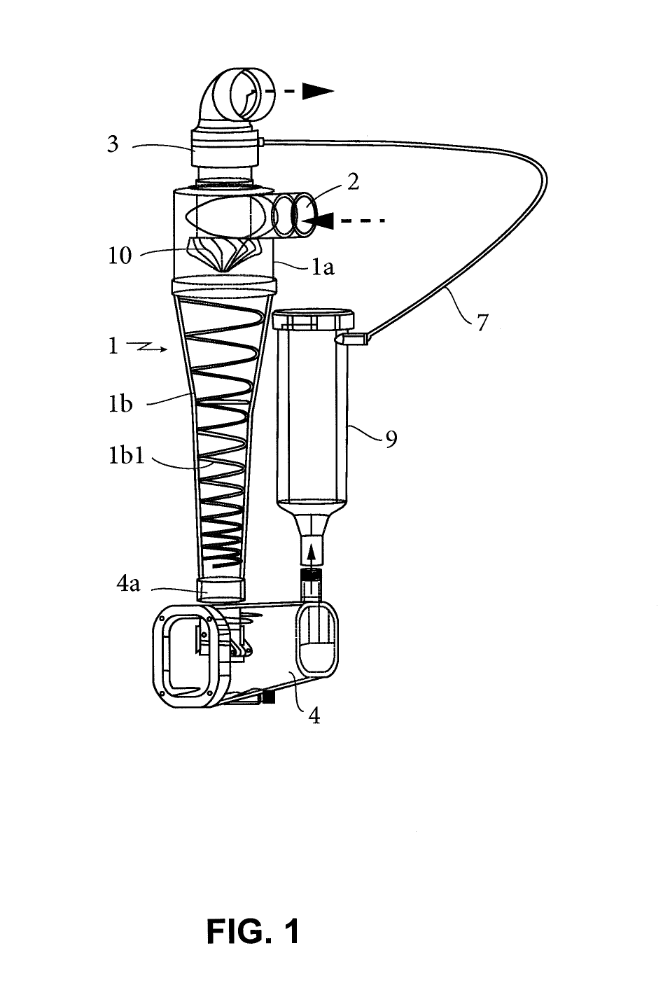

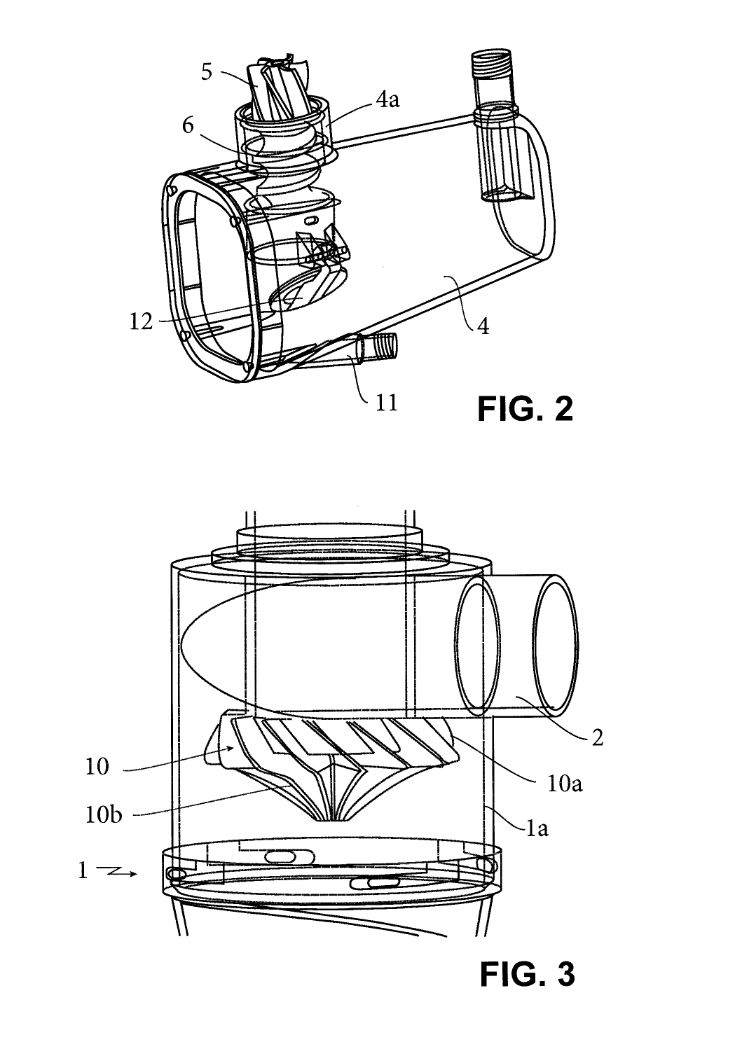

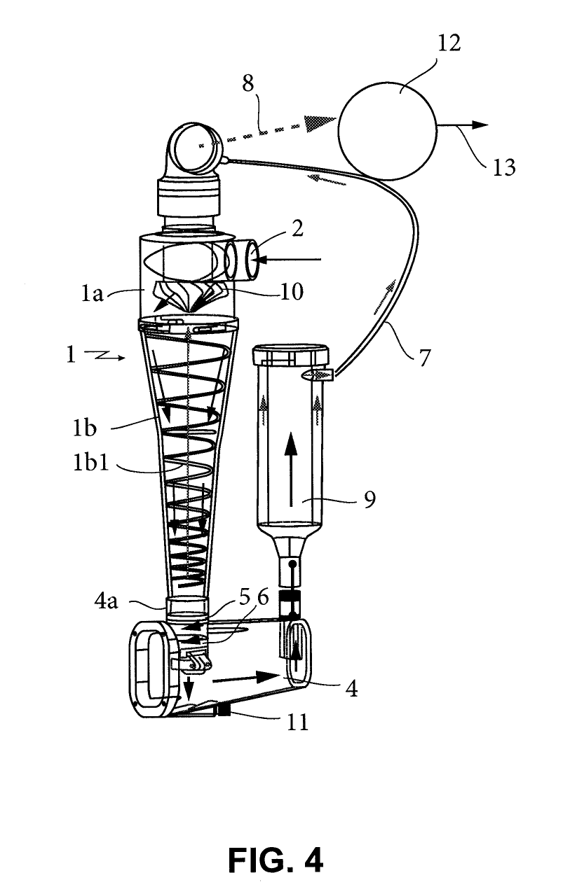

### DETAILED DESCRIPTION

The filtering device according to the embodiments of the disclosure comprises a body 1 which constitutes a hydrocyclone comprising, in its upper part, a cylindrical segment 1a which extends at one of the ends thereof, by a conical segment 1b with a tapering section in a downward direction. The cylindrical segment 1a of the hydrocyclone is in lateral communication with a fitting such as, for example, a line 2 for the liquid entry into the hydrocyclone. The line 2 is suitably arranged so that the liquid to be filtered enters tangentially to the circumference of the body 1 in the vicinity of the internal wall thereof so that the solid particles that may be contained in the liquid tend to be pushed against the wall under the effect of the centrifugal force. The fluid follows the wall of the body 1 to the apex of the frusto-conical portion 1b and, by a vortex effect, rises up through the center of the body while being free of a certain amount of particles. The liquid is then discharged through a fitting, for example, in the form of a water outlet pipe 3 positioned coaxially with the upper part of the cylindrical segment 1a. These characteristics are well known to the persons skilled in the art and constitute the general principle of cyclonic filtration.

According to one embodiment of the disclosure, the frusto-conical segment 1b at the apex, has fittings that aim at ensuring the extraction and the discharge of the solid particles captured in order to guide the same into a tank 4. Such means consist of a turbine 5 positioned in coaxial alignment with an endless screw 6. The turbine 5 and the screw 6 are mounted so as to be free to rotate in a connecting sleeve 4a mounted at the free end of the frusto-conical segment 1b and in communication with the tank 4. Under the effect of the turbine 5 and the screw 6 being driven into rotation by the liquid, the particles captured at the wall of the hydrocyclone are extracted from the wall to be guided into the tank 4 where they are no longer subject to the power of the cyclonic effect, which thus eliminates the risk, after a while, of rising up with the liquid.

According to another characteristic, in order to accelerate the extraction of the particles, it is important to create a continuous flow into the tank 4 to keep the particles inside the tank. For this purpose, the hydrocyclone is working in closed circuit and under low pressure. Thus, the tank 4 is in communication via a pipe 7 or another means, with the water outlet pipe 3 being in combination with a suction circuit 8.

Advantageously, a filter 9 of any known and suitable type is mounted at the outlet of the tank 4 for the return water in a closed circuit.

Another important problem to be solved by the disclosure consists of avoiding the re-injection of some particles that, under the effect of the cyclone eye, tend to rise back up. This is particularly true for fine particles. For this purpose, the cylindrical segment 1a of the body 1 of the hydrocyclone has coaxially in alignment with the outlet pipe 3, means capable of pushing back the particles onto the wall of the body at the time of entry of the liquid and pushing back, during the rising up of the liquid, any particles that might still be contained in the liquid. In one embodiment, the means consist of a dual turbine 10 mounted so as to be free to rotate by being positioned coaxially with the segment 1a in alignment with the water outlet pipe 3 as shown. As shown in FIG. 3, such dual turbine 10 consists of an internal turbine 10a and an external turbine 10b. The internal turbine 10a has blades so oriented as to deflect the flow of the incoming liquid and, therefore, the particles against the body wall. The external turbine 10b has blades so oriented as to deflect the particles outward, but still toward the wall during the rising back up of the liquid.

Therefore, resulting from such provisions, impurities and other solid particles, which tend to rise back up with the liquid, are projected outward, outside the flow.

Still, with the aim of improving the efficiency of the hydrocyclone, the internal wall of the frusto-conical portion 1b has fittings aiming at facilitating the flow toward the apex of the captured particles. Such fittings advantageously consist of a rib 1b1 forming a helicoid.

According to another embodiment, the tank 4 is equipped with means capable of allowing the simultaneous supply with water from the network or the filtration unit and the closing of the hydrocyclone.

The purpose of such provisions is to allow the discharge of the tank in relation with an external pipe 11 for discharging the captured solid particles. For example, in one embodiment, such means may consist of a valve system 12 mounted at the junction of the apex of the frusto-conical segment 1b with the tank 4, under the endless screw 6.

Considering the efficiency of the filtration obtained, the device according to the embodiments of the disclosure can be advantageously applied to the filtering of all kinds of solid particles, including the fine particles that may be contained in any type of liquid or fluid.

The device finds an advantageous application in the field of swimming pool filtering. For this purpose, the device is mounted in combination with a suction and discharge circuit for the water of the swimming pool considered. For example, in one embodiment, the line 2 at the inlet of the water to be filtered is in communication with the water of the swimming pool via at least one skimmer. The discharge line 3 of the filtered water is connected to the suction circuit 8 of a pump 12 for the same to be discharged through a line 13 in the swimming pool.

The advantages are apparent from the description, and are particularly emphasized and recalled:
the operation of the hydrocyclone in a closed loop with a circulation system with a centrifugal force and a vortex at its center by creating a continuous flow of liquid in the lower part of the hydrocyclone at the settling tank,
the mounting of a turbine combined with an endless screw at the bottom of the hydrocyclone, under the eye of the cyclone, so as to extract the particles and move the same into a retention tank with, as a result, avoiding taking away some previously captured and isolated particles.
the dual turbine on the return of the hydrocyclone is driven by the rotation of water so as to push back the solid particles against the walls of the hydrocyclone at both the water inlet and outlet.

1. A device for filtering a liquid by cyclonic effect, comprising: a tubular body with a cylindrical segment extended at one of the ends thereof by a conical segment with a tapering section, the other end of the cylindrical segment being in lateral communication with a fitting for the entry of the liquid to be filtered tangentially to the circumference of the body next to the wall such that solid particles of the liquid, under the effect of the centrifugal force, tend to be pushed against the wall, with the fluid following the wall until the apex and rising back up free of at least some of the particles via the center of the body so as to be discharged via a coaxial fitting of the cylindrical segment, and
wherein, the end of the conical segment considered at the apex thereof, has means capable of allowing the extraction and discharge of solid particles captured at the wall of the body in order to guide same into a tank in communication with the coaxial fitting.

2. The device according to claim 1, wherein the body has, coaxially with the cylindrical surface thereof, means capable of pushing back the particles onto the wall of the body upon the entry of the liquid and of pushing back the particles, if any, that the liquid might still contain, during the rising of the liquid.

3. The device according to claim 1, further comprising a filter positioned between the tank and the coaxial fitting.

4. The device according to claim 1, wherein the inner wall of the conical segment of the body has fittings for facilitating the flow of the captured particles toward the apex.

5. The device according to claim 1, wherein the fittings of the end of the conical segment at the apex thereof consist of a turbine positioned in coaxial alignment with an endless screw, with the turbine and the screw being so mounted as to be free to rotate in a sleeve providing the connection and the communication between the end and the tank.

6. The device according to claim 2, wherein the means that the body has at the cylindrical segment thereof consist of a dual turbine so mounted as to be free to rotate by being positioned coaxially with the cylindrical segment.

7. The device according to claim 6, wherein the dual turbine consists of two internal and external concentric turbines, the internal turbine having blades oriented so as to deflect the flow of the incoming liquid against the wall of the body, the external turbine having blades oriented so as to deflect the particles outward toward the wall during the rising back up of the liquid.

8. The device according to claim 1, wherein the tank is equipped with means capable of enabling the simultaneous supply thereof with water from the network or the filtration unit and closing of the hydrocyclone for the emptying thereof in relation to an external pipe.

9. The device according to claim 4, wherein the fittings of the internal wall of the conical segment of the body consist of a rib forming a helicoid.

10. The device of claim 1, wherein the device is mounted in combination with a suction and discharge circuit for the water of a swimming pool.

11. The device according to claim 10, wherein the fittings for the entry of the liquid consist of a line in communication with the water of the swimming pool via at least one skimmer.

12. The device according to claim 10, wherein the fittings for the discharge of the filtered liquid consist of a pipe connected to the suction circuit of a pump for the discharge thereof into a swimming pool.

13. The device according to claim 2, wherein the inner wall of the conical segment of the body has fittings for facilitating the flow of the captured particles toward the apex.

14. The device according to claim 3, wherein the inner wall of the conical segment of the body has fittings for facilitating the flow of the captured particles toward the apex.

15. The device of claim 2, wherein the device is mounted in combination with a suction and discharge circuit for the water of a swimming pool.

16. The device of claim 4, wherein the device is mounted in combination with a suction and discharge circuit for the water of a swimming pool.

17. The device according to claim 11, wherein the fittings for the discharge of the filtered liquid consist of a pipe connected to the suction circuit of a pump for the discharge thereof into a swimming pool.
